(19) United States
(12) Patent Application Publication
(10) Pub. No.: US 2007/0006447 A1
(43) Pub. Date: Jan. 11, 2007

(54) Automated continuous operation tube forming system

(76) Inventor: M. Craig Webster, Novi, MI (US)

Correspondence Address: CARRIER BLACKMAN AND ASSOCIATES, 24101 NOVI ROAD, SUITE 100, NOVI, MI, 48375, US

(21) Appl. No.: 11/438,471

(22) Filed: May 22, 2006

Related U.S. Application Data
(60) Provisional application No. 60/683,398, filed on May 20, 2005.

(51) Int. Cl. B23P 21/00; B23Q 15/00

(52) U.S. Cl. 29/714; 29/709; 29/711; 29/712

(57) ABSTRACT

An automated, continuous tube forming system comprising: a plurality of workstations which respectively perform various operations on a workpiece; an indexing transfer carousel having a plurality of workpiece-holding collets provided in a spaced arrangement around the periphery-circumference of the of the carousel and which are adapted to support a plurality of workpieces, respectively, the multiple workstations are provided around the indexing transfer carousel and the carousel is selectively rotated to move the collet-supported workpieces such that the workpieces are associated with the workstations where various operations can be performed on the workpieces; a loading device which loads workpieces on the indexing transfer carousel; a transfer device which unloads the finished workpieces from the indexing transfer carousel after processed at the workstations; and a controller which controls operations of the indexing transfer carousel, the workstations, the loading device, and the transfer device. Electrical power may be provided to the indexing transfer carousel via a movable type power connector such as a slip-ring connector, operations of the indexing transfer carousel, the workstations, the loading device, and the transfer device are continuously monitored using appropriate sensors, and the sensors communicate with the controller via wireless communication signals such as RF signals.

### BACKGROUND OF THE INVENTION

1. Field of the Invention

The present invention relates to an automated tube forming system and method, and more particularly to such a system and method with significantly increased productivity of parts because the system can be run continuously and wirelessly without human operators, and within a significantly reduced space.

2. Description of the Background Art

There are many known systems and methods for tube forming, including systems and methods which are partially or fully automated. Typically, a tube forming operation may involve multiple processing steps for the tubing, e.g., steps of bending (compression, draw, mandrel, non-mandrel), drilling, sizing (expanding or reduction), cutting (shear, laser, plasma), notching, etc. Typically at least some of the various operations are performed using different machines located separately from each other, so that the tubing being formed is moved between the different machines-locations as it is being processed. Also typically, human operator(s) are required to be involved in the forming operation, e.g., for loading—unloading parts, moving parts from one location or machine to another, etc. As will be understood, greater involvement of human operator(s) in a given tube forming operation, usually results in less efficiency and productivity for the operation.

Moreover, even if a tube forming operation is performed in an automated manner involving one or more machines, typically the machines have inherent limitations which prevent them from being used continuously. For example, while it is known to wirelessly provide electrical power to a machine which rotates using a so-called “slip-ring” connection, such machines nonetheless include some wiring for purposes of monitoring operations, supplying control signals, etc. to assure that the automated process is performed properly. Such wiring may be of very small gage-size because the signals are of a low energy level, and may be wound or flexed to a great extent, but ultimately the wiring has some limit at which it must be unwound, counter flexed, etc. or it will fail. Hence, the machines cannot be operated continuously.

Still further, with conventional automated tube forming methods the various processing operations are typically performed using different machines spaced about an area with conveyors or the like used to transport parts between the different operations. Such an arrangement is not particularly efficient in terms of space utilization, whereas the time and delay involved in transporting parts between operations detracts from efficiency and productivity.

Hence, while the known systems and methods are effective for their purpose, they remain to be improved in terms of production cost, simplicity of use and design, effectiveness, etc. Thus, a need still exists in the art for an improved tube forming system and method which can be efficiently operated/performed in a continuous, fully wireless, space efficient, automated manner.

### SUMMARY OF THE INVENTION

It is an object of the invention to fulfill the discussed need in the art.

According to an aspect of the invention, there is provided an automated, continuous tube forming system comprising: a plurality of workstations which respectively perform various operations on a workpiece; an indexing transfer carousel having a plurality of workpiece-holding collets provided in a spaced arrangement around the periphery-circumference of the carousel and which are adapted to support a plurality of workpieces, respectively, the multiple workstations being situated around the indexing transfer carousel and the carousel being selectively rotated to move the collet-supported workpieces such that the workpieces are associated with the workstations where various operations can be simultaneously performed on the workpieces; a loading device which loads workpieces on the indexing transfer carousel; a transfer device which unloads the finished workpieces from the indexing transfer carousel after being processed at the workstations; and a controller which controls operations of the indexing transfer carousel, the workstations, the loading device and the transfer device. Electrical power may be provided to the indexing transfer carousel via a movable type power connector such as a slip-ring connector. The operations of the indexing transfer carousel, the workstations, the loading device, and the transfer device may be continuously monitored using appropriate sensors. The sensors may communicate with the controller via wireless communication signals such as RF signals.

Such system according to the invention may also include one or more servo motors or other appropriate devices associated with each collet to rotate or otherwise move a workpiece as supported by the collet to thereby facilitate forming on multiple planes. Also, the workstations may each be capable of operation involving rotation or other movement in multiple directions to minimize the possibility of interference between the workpiece and the workstation.

Such tube forming system according to the invention is very advantageous because it can be fully automated and operated continuously and wirelessly to achieve a very high level of efficiency and productivity. For example, because all of the workstations are associated with a single carousel, the workstations are efficiently disposed within a very small area in comparison to the conventional arrangements. Further, there is no need for a conveyor or the like to move parts between the different processing operations as the indexing transfer carousel simply moves—rotates the parts from one operation to the next in a highly efficient manner, e.g., an unprocessed part is loaded onto the carousel, is then processed through a number of operations, and then unloaded or discharged from the carousel as a finished or semi-finished part. Still further, processing of parts at each of the workstations occurs simultaneously, such that the operation which takes longest to perform essentially determines or corresponds to the cycle time/period for rotating the carousel one increment/stage, and similarly determines the effective length of time required for the system to fully process one part or tube.

Additionally, the indexing transfer carousel includes the slip-ring type power connection for providing power to the collet servo motors and the like, such that there is no concern that associated wiring would require shut down of the system at some point in time. Similarly there are no wires for providing low energy level signals between the sensors associated with the indexing transfer carousel and the controller, therefore resulting in no concern relating to the inherent limitations of such wires. Thus, the system may be operated substantially continuously, e.g., with the indexing transfer carousel being continuously rotated in a single direction, in produced parts such as formed tubing.

According to another aspect of the invention there is provided a method of using the automated, continuous tube forming system of the invention as discussed above.

The above and other objects, features and advantages of the invention will become apparent from the following description of the present embodiment taken in conjunction with the accompanying drawings. It should be understood, however, that the detailed description of specific examples, while indicating the present embodiments of the invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is plan schematic view of a complete automated, continuous tube forming system according to an embodiment of the invention.

FIG. 2 is an enlarged portion of FIG. 1.

FIG. 3 is a frontal perspective view corresponding to the enlarged portion of FIG. 2, but showing greater detail of the system.

FIG. 4 is a side perspective view similar to FIG. 3, but shown from a different angle.

FIG. 5 is a further enlarged portion of FIG. 4.

### DETAILED DESCRIPTION

Referring to the drawings, an automated, wireless, continuous tube forming system according to the present embodiment of the invention is indicated at 1. The system 1 includes an indexing transfer carousel 2 having a plurality of workpiece-holding collets 4 provided thereon in a uniformly spaced manner around the periphery-circumference thereof, and which are adapted to support workpieces such as a length of tubing, a length of tubing with end fittings, etc. In the depicted embodiment, eight of the collets 4 are provided on the carousel which is octagonal in shape, although the invention is not limited to any particular number collets or carousel shape. Similarly, it is not essential for the collets to be uniformly spaced on the carousel 2, or for the workpiece to be a length of tubing.

The system 1 further includes a plurality of workstations 6 disposed around the periphery of the carousel 2 which will perform various operations on the workpieces when the workpieces are moved into the workstations by the carousel 2. In the depicted embodiment, there are six workstations, a workpiece loading station 7, and an unloading station 8. In the depicted embodiment, the collective number of workstations 6, and the loading and unloading stations are eight, respectively corresponding to the eight collets 4 on the carousel.

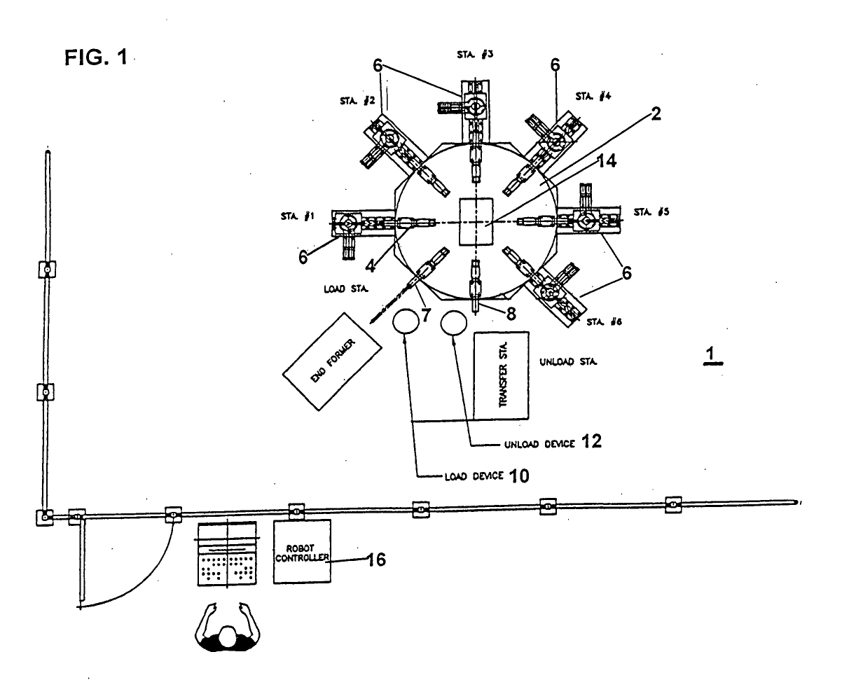

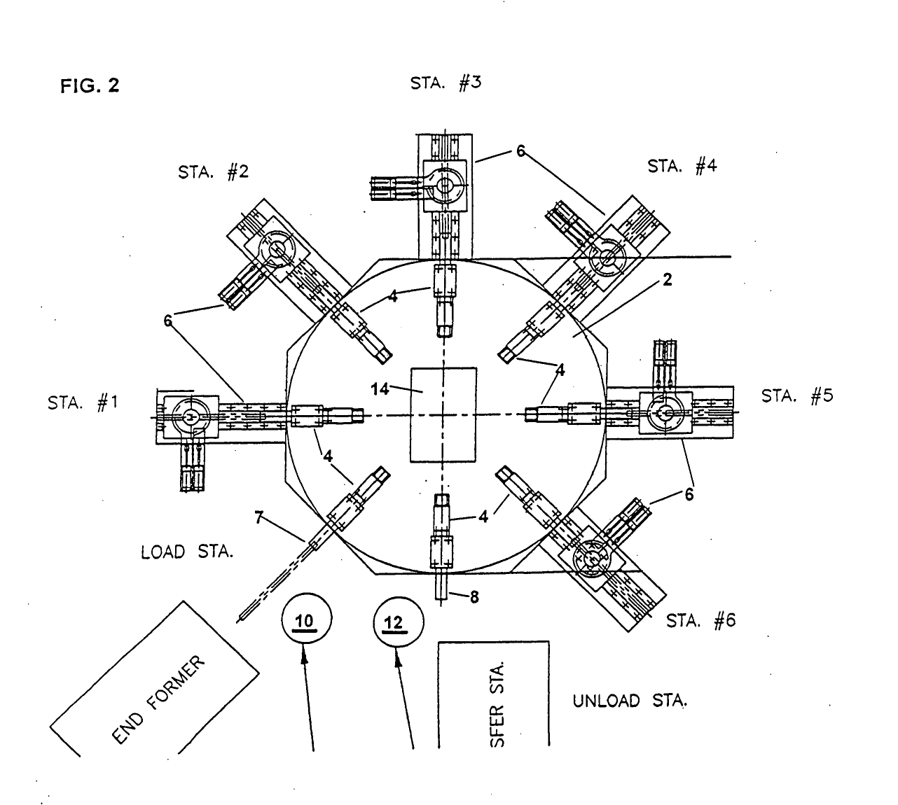

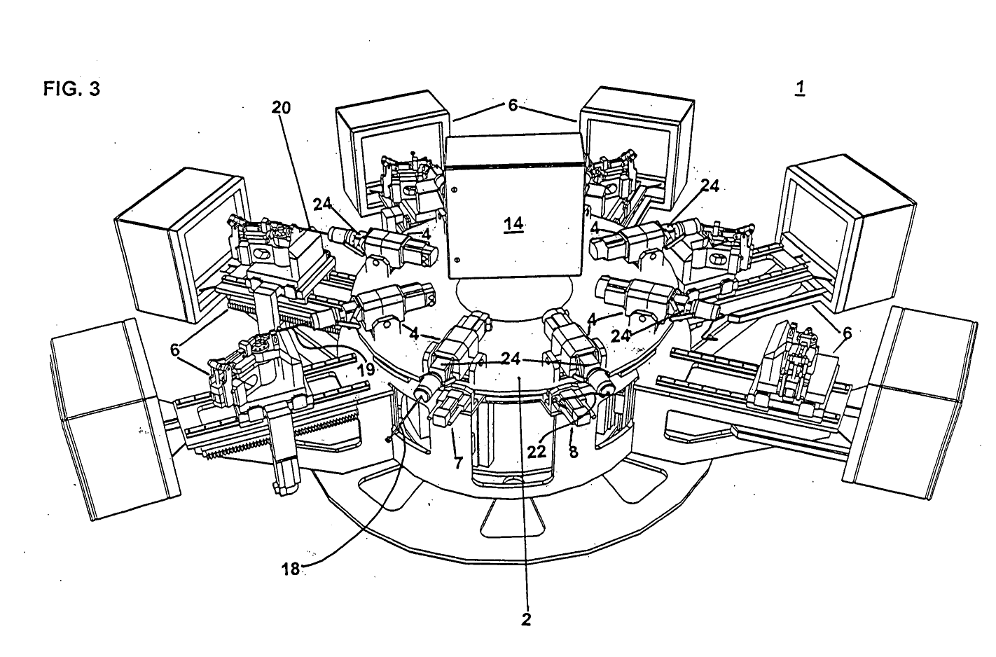

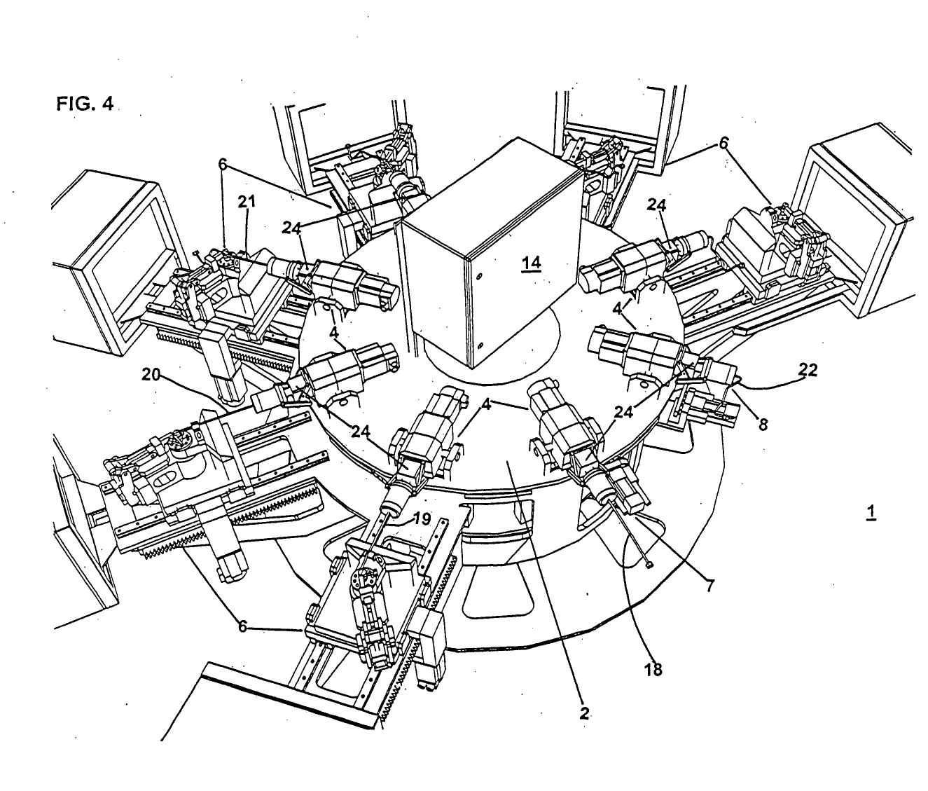

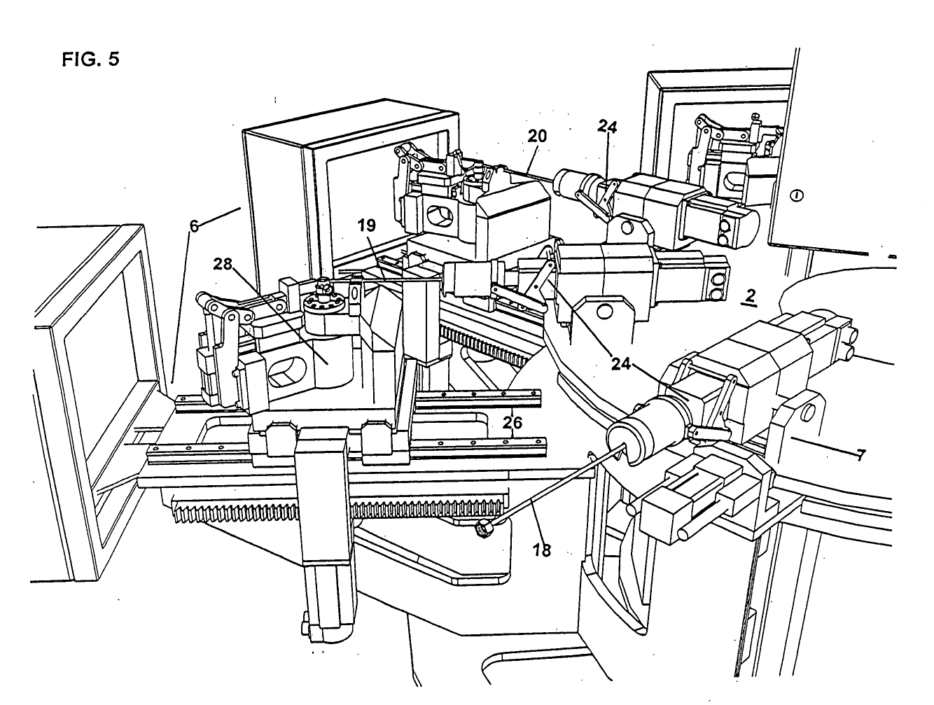

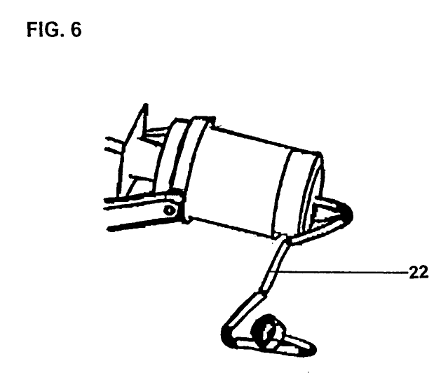

Each of the workstations 6 may be dedicated to a single operation on a workpiece, such as bending, end forming, drilling, cutting, shearing, notching, etc., and each of the workstations will be operating simultaneously on respective workpieces, while a finished workpiece is unloaded at the unloading station 8 and a fresh workpiece is loaded into the collet at the loading station 7. Loading and unloading of workpieces is performed by appropriate automated devices schematically shown at 10, 12 in FIGS. 1 and 2, but are not shown in FIGS. 3-5.

In the depicted embodiment of the present invention, a workpiece is loaded into the collet 4 which is located at the loading station 7. After a pre-determined amount of time, e.g., 3-5 seconds, the entire indexing transfer carousel 2 and subsequently each collet 4 holding a workpiece is lifted vertically along the Y-axis away from its associated workstation 6 by a motor or similar device (not shown) located in the stationary portion of the carousel 2, e.g., beneath the planar upper surface thereof. After the transfer carousel 2 is lifted, the entire carousel is rotated around the center of the carousel 2 by a pre-determined amount-increment such that each collet 4 is now located adjacent the next workstation 6, loading station 7 or unloading station 8. In the depicted example, there are six workstations 6, one loading station 7 and one unloading station 8 located around a octagonal indexing carousel 2, totaling eight stations in all. Each of the workstations 6, the loading station 7 and the unloading station 8 may be spaced equidistant from the adjacent stations around the periphery/circumference of the carousel 2, e.g., 45° away from the adjacent stations. With such an arrangement, when the indexing carousel 2 is moved or incremented, it may be rotated 45° each time to move each collet 4 to the next station. The indexing transfer carousel 2 may then be lowered to bring each workpiece in position for the new station.

With particular reference to FIGS. 3-5, as each new workpiece 18 is loaded into the collet 4 located at the loading station 7, simultaneously the workpiece 19 loaded before the last rotation of the carousel 2 is undergoing its first forming operation at the first workstation 6, a second workpiece 20 is being operated upon at the second workstation in the rotation, a third workpiece 21 is being operated on at the third workstation, etc., such that a finished workpiece 22 is generated at the last workstation and then discharged at the unloading station 8. After the next rotation of the carousel 2, the first workpiece 18 will take the place of the second workpiece 19, which will take the place of the third workpiece 20, etc. Further, each time a new workpiece is loaded into the collet 4 located at the loading station 7 a finished workpiece is dispensed at the unloading station 8. Accordingly, with each rotation a completed product is dispensed from the system. Per-workpiece cycle time is dictated only by the slowest of the operations to be performed by the several workstations 6, plus the time required to index the carousel 2. For example if the slowest operation being performed on the workpiece is at the first workstation, the operation taking four seconds to complete, and it takes one second to cycle-index the carousel by one increment, a completed workpiece will be dispensed at the unloading station 8 approximately every five seconds.

Each collet 4 on the carousel 2 may have one or more servo motors 24 or other appropriate devices associated therewith for rotating or otherwise moving the collet 4 and the workpiece supported thereby, e.g. a servo motor 24 may be associated with each collet 4 such that the collet 4 may rotate the workpiece around the B-axis if desired or required for the next operation, or may be rotated around the B-axis to disengage the workpiece from a workstation, etc. This efficiently facilitates forming of the workpiece on multiple planes since the workpiece may be rotated into a new position at any appropriate time, such as while the carousel is being rotated through one increment.

Electrical power may be provided to the indexing transfer carousel 2 and to the servo motors via a movable type power connector such as a slip-ring connector (not shown). The use of such a power connector allows the indexing transfer carousel 2 to rotate continuously in a single direction through the elimination of wires that conventionally would get entangled around the rotating mechanism of the carousel and need to be unwound.

Also, operations of the indexing transfer carousel 2, the workstations 6, the loading device 10, and the unloading device 12 are continuously or otherwise appropriately monitored using appropriate sensors generally indicated at 25. The sensors may communicate with the host controller 16 and the microcomputer 14 via wireless communication signals such as RF signals. This is a very important aspect of the invention, again, because the absence of wiring between the sensors, the host controller 16, and the microcomputer 14, etc. permits the carousel 2 and the associated workstations 6, the loading device 10, and the unloading device 12 to be operated continuously or substantially continuously. Particularly, absence of the signal wires eliminates the conventional limitations associated therewith.

The indexing transfer carousel 2 is capable of continuously rotating in one direction, and to avoid a conventional need for external wiring to each of the collet servo motors, a microcomputer 14 with related electronics, programming, memory, etc. may be located within the indexing transfer carousel 2. In conventional systems, the external wiring could become entangled as the machine operates. Thus, after a number of operations/rotations the machine would have to be unwound so as to prevent any damage to the machine or its parts. This untangling/unwinding process significantly decreases efficiency/productivity of the machine. As shown in the depicted embodiment the indexing carousel 2 will continuously, incrementally rotate in one (clockwise) direction, never having to be rotated in the opposite (counterclockwise) direction in order to untangle wires on the carousel 2 or the like.

While or after the indexing transfer carousel 2 is rotated through one increment, such that the workpiece is in position above a workstation 6, the servo motor 24 associated with the collet 4 holding the workpiece may rotate the workpiece around the B-axis until it is in the correct position for a next operation before the indexing transfer carousel 2 is lowered. After the carousel 2 is lowered, the workstation 6 secures the workpiece in place by clamping or the like such that the desired operation or manipulation may be performed. Each workstation 6 may be disposed on tracks 26 such that the workstation 6 may move towards or away from the carousel 2. This ensures that the workstation 6 will continue to hold the metal tube in place while the desired operation is being performed. In the depicted embodiment, an arm 28 located at the back end of the workstation 6 is rotatably connected to the rest of the workstation 6, though depending on the desired operation of the workstation the arm may be connected in various ways or have various different features. The arm 28 moves into place when the workpiece is secured in the workstation 6 and creates the desired bend (or performs another operation) in the workpiece according to pre-determined specifications. The indexing transfer carousel 2 may then be raised, thereby lifting the workpieces from the associated workstations 6, and rotated such that the workpieces are moved to the next stations. As the index transfer carousel 2 is rotating the collets 4 and associated workpieces to the next workstations 6, each workstation 6 may be reset in order to efficiently prepare to perform the same operation on the next workpiece.

The workstations 6 may each be capable of operation involving rotation or other movement in multiple directions to minimize the possibility of interference between the workpiece and the workstation. For example, if the workstation involves use of a bending head for bending the workpiece, the bending head may be capable of clockwise and counter-clockwise operation to minimize the possibility of interference between the workstation and the workpiece. In this manner, the workstations may be compactly arranged around the indexing transfer carousel 2.

As shown in FIG. 6, a finished workpiece 22 in the depicted embodiment may be a length of tubing with compression fittings on the opposite ends thereof, and which has multiple intricate bends formed therein. Such a workpiece may be used as a fuel line for providing fuel to an injector of an engine.

Although the exemplary embodiment of bending a tube is described above, the workstations 6 may perform any one of diverse operations including but not limited to bending, drilling, expanding, cutting, notching, shearing, etc. a tube. Further, though each workstation 6 may perform similar operations on a single workpiece, e.g. each workstation 6 creates a different bend in the workpiece, it is also possible for each station to perform different operations on a single workpiece, i.e. one workstation will bend the workpiece while another workpiece will expand a different portion of the workpiece, and yet another workstation will cut the tubing, etc.

Thus, for example, the system 1 may be a fully automatic, high speed rotary indexing system which simultaneously performs all tube forming operations needed to produce a part such as a diesel fuel injector from a workpiece such as a length of tubing. Thus, the system 1 can equal and surpass the output of multiple conventional tube forming machines requiring human operator(s), and do so using far less space.

Although the present embodiment of the invention has been described, it will be understood by persons skilled in the art that variations and modifications may be made thereto without departing from the gist, sprit or essence of the invention. The scope of the invention is indicated by the appended claims. For example, the present invention is not limited to processing of tubing as the workpiece, but may be used to process any other type of workpiece which requires multiple processing operations. Further, the carousel need not be any particular shape, nor is it limited to any number of workstations. Still further, it is possible for a system to include more than one carousel spaced vertically from each other, with each carousel including a number of collets and being associated with a number of workstations, etc. for further enhanced productivity.

I claim:

1. An automated, continuous tube forming system comprising:
a plurality of workstations which perform various operations on a workpiece;
an indexing transfer carousel having a plurality of workpiece-holding collets provided in a spaced arrangement around a periphery of the carousel and which are adapted to support a plurality of workpieces, respectively;
the multiple workstations being provided around the indexing transfer carousel and the carousel being selectively rotated to move the collet-supported workpieces such that the workpieces are associated with the workstations where the various operations can be performed on the workpieces;
a loading device which loads workpieces on the indexing transfer carousel;
a transfer device which unloads the finished workpieces from the indexing transfer carousel after being processed at the workstations;
and a controller which controls operations of the indexing transfer carousel, the workstations, the loading device, and the transfer device.

2. The automated, continuous tube forming system of claim 1 wherein electrical power is provided to the indexing transfer carousel through a movable type power connector.

3. The automated, continuous tube forming system of claim 2 wherein the movable type power connector comprises a slip-ring connector.

4. The automated, continuous tube forming system of claim 1 further comprising:
sensors which monitor operations of the indexing transfer carousel, the workstations, the loading device, and the transfer device, and the sensors communicate with the controller through wireless communication signals.

5. The automated, continuous tube forming system of claim 4 wherein the wireless communication signals comprise radio (RF) signals.

6. The automated, continuous tube forming system of claim 1 further comprising:
servo motors associated with each collet wherein each collet may be moved in order to move the workpiece supported by the collet.

7. An automated, continuous tube forming system comprising:
a plurality of workstations which perform various operations on a workpiece;
an indexing transfer carousel having a plurality of workpiece-holding collets provided in a spaced arrangement around a periphery of the carousel and which are adapted to support the plurality of workpieces, respectively;
the multiple workstations being provided around the indexing transfer carousel and the carousel being selectively rotated to move the collet-supported workpieces such that the workpieces are associated with the workstations where the various operations can be performed on the workpieces;
a controller which controls operations of the indexing transfer carousel and the workstations; and
sensors which continuously monitor operations of the indexing transfer carousel, and the workstations, wherein the sensors communicate with the controller through wireless communication signals.

8. The automated, continuous tube forming system of claim 7 wherein electrical power is provided to the indexing transfer carousel through a movable type power connector.

9. The automated, continuous tube forming system of claim 8 wherein the movable type power connector comprises a slip-ring connector.

10. The automated, continuous tube forming system of claim 7 wherein the wireless communication signals are radio (RF) signals.

11. The automated, continuous tube forming system of claim 7 further comprising:
servo motors associated with collets, wherein each collet may be moved in order to move the workpiece supported by the collet in at least one of radial, axial and lateral directions.
